(19) United States
(12) Patent Application Publication
(10) Pub. No.: US 2015/0272149 A1
(43) Pub. Date: Oct. 1, 2015

(54) FERMENTED MILK PRODUCT

(71) Applicant: DuPont Nutrition Biosciences ApS, Copenhagen K (DK)

(72) Inventor: Kirsten Lauridsen, Vejle (DK)

(73) Assignee: DuPont Nutrition Biosciences ApS, Copenhagen K (DK)

(21) Appl. No.: 14/410,052

(22) PCT Filed: Jun. 26, 2013
(86) PCT No.: PCT/EP2013/063385

§ 371 Date: Dec. 19, 2014

Related U.S. Application Data
(60) Provisional application No. 61/664,484, filed on Jun. 26, 2012.

(30) Foreign Application Priority Data
Jun. 26, 2012 (EP) 12173621.9

(51) Int. Cl. A23C 9/123

(52) U.S. Cl. CPC A23C 9/123

(57) ABSTRACT

The present invention relates to a fermented milk product such as a low-fat fermented milk product comprising an unsaturated emulsifier.

### FIELD OF THE INVENTION

The present invention relates to a fermented milk product such as a non-fat or low-fat fermented milk product, such as stirred yogurt and drinking yogurt, and a method for preparing a fermented milk product, and use of an unsaturated emulsifier for improving characteristics of a low-fat fermented milk product.

### BACKGROUND OF THE INVENTION

Fermented milk products include dairy foods that have been fermented using lactic acid bacteria such as Lactobacillus and Lactococcus. The fermentation process converts carbohydrate into lactic acid, which increases the shelf-life of the product, as well as enhancing the taste and improving the digestibility of milk. Cheese, yogurt, sour cream and creme fraiche are examples of such products.

Yoghurt is a traditional product consumed widely since ancient times. It is now very popular as a snack food or beverage especially in the form of low calorie yogurt. Yoghurt has been attributed with a variety of health properties. Apart from the benefits of an easily digested quantity of high quality protein and the benefits attributed to the consumption of large numbers of lactic acid producing micro-organisms, and the products of their metabolism, yoghurt, along with many dairy products, is an important source of calcium in the human diet.

Non-fat or low-fat fermented milk products having low calorie content are popular; however, fermented milk products that maintain a flavour, body and the texture of fat are desired. Especially non-fat or low-fat yogurt are lacking fat sensation as well as being more acidic and/or bitter than full-fat yogurt.

Presently, in order to maintain the flavour, body and texture of fat of fermented milk products, gelatin, starch, milk protein and/or pectin have been used for texture building in order to compensate for the lack of fat. This is claimed to give a fatty impression, although it is believed that the fatty impression comes from the fact that the product presents a higher level of texture.

WO03/103410 relates to a gelatine free dairy dessert comprising less than 10 w/w % fat and an unsaturated emulsifier.

US 2005/0026999 relates to compositions comprising lactic acid esters of mono- and diglycerides of fatty acids i.e. LACTEM compositions. A low fat yogurt made with pectin and containing LACTEM is described.

It is an object of the present invention to provide a method for preparing a non-fat or low-fat fermented milk product having increased fat sensation, increased cream flavor, decrease in acidity perception, and/or decrease in powdery sensory.

It is a further object to obtain these improved characteristics without a decrease in measured viscosity or sensory viscosity.

### SUMMARY OF THE INVENTION

It has been found by the present inventor(s) that it is possible to obtain a fermented milk product having improved characteristics such as an increased fat sensation, increased cream flavor, decreased acidity perception, and/or decrease in powdery sensory by adding an unsaturated emulsifier. In one aspect, the unsaturated emulsifier is added in an amount of 0.01-0.19 w/w %, such as 0.05-0.19 w/w %, preferably in an amount of 0.01-0.15 w/w %. It has further been found that in some embodiments these characteristics such as perceived acidity and/or an increased fat sensation are especially improved. It has further been found that in some embodiments this may be achieved without a decrease in measured viscosity or sensory viscosity.

In an alternative embodiment, the present inventors have found that it is possible to obtain a fermented milk product having improved characteristics such as an increased fat sensation, increased cream flavour, decreased acidity perception, and/or decrease in powdery sensory by adding mono- and diglyceride(s) of unsaturated fatty acid(s). In one aspect, the mono- and diglyceride(s) of unsaturated fatty acid(s) is added in an amount of 0.01-0.19 w/w %, such as in an amount of 0.05-0.19 w/w %, preferably in an amount of 0.01-0.15 w/w %. It has further been found that in some embodiments these characteristics such as perceived acidity and/or an increased fat sensation are especially improved. It has further been found that in some embodiments this may be achieved without a decrease in measured viscosity or sensory viscosity.

So, in a first aspect the present invention relates to a fermented milk product comprising an unsaturated emulsifier in an amount of 0.01-0.19 w/w % such as in an amount of 0.05-0.19 w/w %, wherein the fermented milk product comprises at least 0.3 w/w % fat.

In a second aspect, the present invention relates to a method for preparing a fermented milk product having an increased fat sensation by adding an unsaturated emulsifier in an amount of 0.01-0.19 w/w % such as in an amount of 0.05-0.19 w/w % to a milk product such as a yogurt milk.

In a third aspect, the present invention relates to a method for preparing a fermented milk product having a decreased acidity perception by adding an unsaturated emulsifier in an amount of 0.01-0.19 w/w % such as in an amount of 0.05-0.19 w/w % to a milk product such as a yogurt milk.

In a fourth aspect, the present invention relates to a method for preparing a fermented milk product having an increased fat sensation and a decreased acidity perception by adding an unsaturated emulsifier in an amount of 0.01-0.19 w/w % such as in an amount of 0.05-0.19 w/w % to a milk product such as a yogurt milk.

In yet a further aspect, the present invention relates to use of an unsaturated emulsifier such as in an amount of 0.01-0.19 w/w % for improving characteristics such as an increased fat sensation, increased cream flavor, decreased acidity perception, and/or decrease in powdery sensory in a fermented milk product.

In another aspect the present invention relates to a fermented milk product comprising mono- and diglyceride(s) of unsaturated fatty acid(s). In a further aspect, the mono- and diglyceride(s) of unsaturated fatty acid(s) is present in an amount of 0.01-0.19 w/w %.

In a further aspect, the present invention relates to a method for preparing a fermented milk product having an increased fat sensation by adding mono- and diglyceride(s) of unsaturated fatty acid(s) such as in an amount of 0.01-0.19 w/w % to a milk product such as a yogurt milk.

In a further aspect, the present invention relates to a method for preparing a fermented milk product having a decreased acidity perception by adding mono- and diglyceride(s) of unsaturated fatty acid(s) such as in an amount of 0.01-0.19 w/w % to a milk product such as a yogurt milk.

In a further aspect, the present invention relates to a method for preparing a fermented milk product having an increased fat sensation and a decreased acidity perception by adding an mono- and diglyceride(s) of unsaturated fatty acid(s) such as in an amount of 0.01-0.19 w/w % to a milk product such as a yogurt milk.

In yet a further aspect, the present invention relates to use of mono- and diglyceride(s) of unsaturated fatty acid(s) such as in an amount of 0.01-0.19 w/w % for improving characteristics such as an increased fat sensation, increased cream flavor, decreased acidity perception, and/or decrease in powdery sensory in a fermented milk product.

### DETAILED DISCLOSURE OF THE INVENTION

In one aspect disclosed herein, the present invention relates to a fermented milk product comprising an unsaturated emulsifier in an amount of 0.01-0.19 w/w % such as in an amount of 0.05-0.19 w/w %, wherein the fermented milk product comprises at least 0.3 w/w % fat.

In another aspect disclosed herein, the present invention relates to a fermented milk product comprising mono- and diglyceride(s) of unsaturated fatty acid(s) such as in an amount of 0.01-0.19 w/w %. In a further aspect, such a fermented milk product further comprises at least 0.3 w/w % fat. In a further aspect, the fermented milk product comprises at least 0.3 w/w % fat, such as at least 0.4 w/w % fat, such as at least 0.5% w/w % fat. In a further aspect, the fermented milk product comprises between 0.3 and 15 w/w % fat, such as between 0.3 and 10 w/w % fat or between 0.3 and 8 w/w % fat or between 0.3 and 6 w/w % fat or between 0.4 and 6 w/w % fat, or between 0.4 and 4 w/w % fat or between 0.4 and 2 w/w % fat or between 0.4 and 1.8 w/w % fat.

The term “fat” may be any type of fat, and includes e.g. vegetable fat, milk fat or combinations thereof. Non-limiting examples of milk fat are e.g. butter, cream, butter concentrate, butter oil and fractionated butter. Vegetable fat can e.g. be palm fat, palm kernel fat, coconut fat, or combination of two or more thereof, and may be of natural origin (non-hardened), or (partially) hardened. When the product is a yogurt the fat is usually milk fat such as cream.

As used herein, the term “fermented milk product” refers to a food product made by fermentation of a dairy substrate using at least one species of lactic acid bacteria, such as Lactobacillus, Lactococcus, Leuconostoc, Streptococcus thermophilus, Lactobacillus bulgaricus, Lactobacillus lactic, Leuconostoc mesenteroides subs. lactis, Lactococcus lactis subsp. Cremoris, Lactococcus lactis subsp. Lactis, Lactococcus lactis subsp. lactis biovar. diacetylactis. The lactic acid bacteria are responsible for the production of lactic acid from lactose.

In some embodiments, the products have a low pH (e.g., a pH of about 3 to about 6.0).

In one aspect, the fermented milk product has a pH between 3-5. In yet a further aspect, the fermented milk product has a pH of 3.5-4.6.

In some preferred embodiments, the products contain lactic acid.

Fermented milk products are provided in any form, including frozen, liquid or solid form. In some embodiments, the products contain living bacteria, while in some alternative embodiments, no living bacteria are present. Fermented milk products include, but are not limited to cheese, yogurt, sour cream, creme fraiche, and fermented milk beverages.

In one aspect, the present invention relates to a method for preparing a fermented milk product having an increased fat sensation and/or a decreased acidity perception by adding an unsaturated emulsifier in an amount of 0.01-0.19 w/w % such as in an amount of 0.05-0.19 w/w % to a milk product such as a yogurt milk.

In a further aspect, the present invention relates to a method for preparing a fermented milk product having an increased fat sensation by adding an unsaturated emulsifier in an amount of 0.01-0.19 w/w % such as in an amount of 0.05-0.19 w/w % to a milk product such as a yogurt milk.

In a further aspect, the present invention relates to a method for preparing a fermented milk product having a decreased acidity perception by adding an unsaturated emulsifier in an amount of 0.01-0.19 w/w % such as in an amount of 0.05-0.19 w/w % to a milk product such as a yogurt milk.

In one aspect, the present invention relates to a method for preparing a fermented milk product having an increased fat sensation and/or a decreased acidity perception by adding mono- and diglycerides of unsaturated fatty acid(s) such as in an amount of 0.01-0.19 w/w % to a milk product such as a yogurt milk.

In a further aspect, the present invention relates to a method for preparing a fermented milk product having an increased fat sensation by adding mono- and diglycerides of unsaturated fatty acid(s) such as in an amount of 0.01-0.19 w/w % to a milk product such as a yogurt milk.

In a further aspect, the present invention relates to a method for preparing a fermented milk product having a decreased acidity perception by adding an unsaturated emulsifier such as in an amount of 0.01-0.19 w/w % to a milk product such as a yogurt milk.

In general the usual ingredients of the milk product are first mixed, and then optionally homogenized and/or pasteurised, and fermented under suitable conditions, known by the person skilled in the art, to obtain the desired fermented milk product. In one embodiment, the emulsifier is added to the milk before homogenization, pasteurization and/or fermentation. In one embodiment, the emulsifier is added to the milk before homogenization, pasteurization and fermentation.

In a particular embodiment, the milk product is fermented between 20° C. to 43° C. for a period of 5 to 10 h until reaching a pH of 4.7 to 4.2. The fermented milk product thus obtained is subsequently cooled and stored at this temperature until its consumption. The storage temperature is generally set at 4-6° C. but a break in the cold chain can occur especially in areas wherein storage in cold, dry and constant temperature is difficult.

The fermented milk product can be in a liquid or solid form such as yogurt, stirred yogurt, set yogurt, yogurt like drink, bitter milk, butter milk, sour cream, fresh cheese and cheese. Preferably, the fermented milk product is selected from the group consisting of yogurt, stirred yogurt, set yogurt, and yogurt like drink. In one aspect, disclosed herein the fermented milk product is a yogurt. In one aspect, disclosed herein the fermented milk product is a drinking yogurt. In one aspect, disclosed herein the fermented milk product is a stirred yogurt.

In the aspect wherein the fermented milk product is a yogurt, it can further comprise other microorganisms commonly used in yogurt manufacture such as Streptococcus thermophilus and/or Lactobacillus bulgaricus, and present a pH of 4.2 to 4.6.

The milk product can comprise either mammal milk, such as cow's milk, goat's milk or sheep's milk, and/or plant milk, such as soy milk. In one aspect, the milk product comprises skimmed milk. In one aspect, the milk product comprises skimmed milk in an amount of at least 90%, such as at least 92%, at least 94%, at least 96%, or at least 97%. In a further aspect, the milk product comprises cream. The amount of cream added may depend on the desired amount of fat in the milk product.

In the present context a “yoghurt milk” is a liquid milk-based starting material for the preparation of yoghurt or a yoghurt drink. The yoghurt milk traditionally comprises casein and whey proteins in the weight ratios between 90:10 casein:whey protein to 20:80, preferably 90:10 to 50:50.

Yoghurt milks are converted to yoghurt or yoghurt drinks by acidification, usually using a bacterial culture.

A “yoghurt” (yogurt) is an acidic and fermented food prepared from a dairy source and viable food approved micro-organisms. Yoghurt possesses gel-like textural attributes. For the purposes of this invention, yoghurt also refers to yoghurt-like products that may include non-dairy derived lipids, flavourings and food-approved stabilisers, acids, plant derived additions and texturizers. Heat treated yoghurt and yoghurt-like products are also included by the term yoghurt. Petit Suisse is also contemplated when referring to yoghurt. Preferably, the yoghurt is a fermented food prepared from a dairy source and viable food approved micro-organisms.

A “yoghurt drink” is an acidic or fermented food prepared from a dairy source and viable microorganisms. Yoghurt drinks possess viscous, cream-like textural attributes and are widely known as drinking yoghurt. For the purposes of this invention yoghurt drinks also refer to yoghurt-like drinkable products that may include non-dairy derived lipids, flavourings and food-approved stabilisers, acids and texturizers. Heat treated drinking yoghurt products are also included by the term drinking yoghurt. Generally drinking yoghurts have a lower protein content that regular yoghurts. More specifically, drinking yoghurts have protein contents generally <2.5% w/w and typically about 2.0% w/w protein or less. Preferably, the yoghurt drink is a fermented food product prepared from a dairy source and viable micro-organisms.

It is contemplated that products falling under the scope of the Codex standard for fermented milks (CODEX Standard 243-2003, and incorporated hereby by reference) are included as either yoghurts or yoghurt drinks.

The term “unsaturated emulsifier” is well known in the art. Such emulsifiers are derived from unsaturated fats and generally constitute a mixture of mono- and diglycerides of unsaturated fatty acids with glycerol. Examples of commercially available unsaturated emulsifier preparations are, e.g., the emulsifiers GRINDSTED PS 217/B, DIMODAN RT PEL/B, DIMODAN ST., of Danisco, Denmark, GRINDSTED Mono Di SL60 of Danisco, Denmark and Myverol 18-35K, 18-92K and 18-50XL PL of Kerry, The Netherlands, or combinations of two or more thereof. Generally, such commercial unsaturated emulsifier preparations may also comprise substantial amounts of other substances, but usually at least 20% (w/w) of the preparations are composed of unsaturated emulsifier, but higher amounts are also common. The monoglycerides may be based on hardened or partially hardened oil, for example rapeseed or palm oil. In some aspects, the unsaturated emulsifier contains trans fatty acids since especially when it is fully or partly based on partially hardened oil, where some of the originally cis-double bonds are converted to trans double bonds during the partially hardening process. The unsaturated fatty acid(s) may be derived from oils and/or fats of vegetable and/or animal origin.

In one asepct, said fatty acid(s) is selected from the group consisting of myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, and a mixture of said fatty acid(s).

In a preferred aspect, the unsaturated emulsifier comprises mono- and diglycerides of unsaturated fatty acid(s). In a further aspect, the unsaturated emulsifier comprises at least 30 w/w % of mono- and diglycerides of unsaturated fatty acid(s), such as at least 40 w/w % of mono- and diglycerides of unsaturated fatty acid(s) or such as at least 50 w/w % of mono- and diglycerides of unsaturated fatty acid(s).

In another preferred aspect, the unsaturated emulsifier is mono- and diglycerides of unsaturated fatty acid(s).

In yet a preferred aspect, at least 50 w/w % of the mono- and diglycerides of unsaturated fatty acid(s) are in the cis form, such as at least 55 w/w % of the mono- and diglycerides of unsaturated fatty acid(s) are in the cis form or such as at least 57 w/w % of the mono- and diglycerides of unsaturated fatty acid(s) are in the cis form.

The emulsifier GRINDSTED PS217/B contains about 32% of unsaturated monoglyceride.

The unsaturated emulsifier is usually added as a powder optionally containing, for example, a flow agent such as Silicon dioxide.

In one aspect, the fermented milk product as described herein comprises the unsaturated emulsifier in an amount of 0.01-0.19 w/w %, or in an amount of 0.05-0.19 w/w %, or in an amount of 0.05-0.18 w/w %, or in an amount of 0.05-0.16 w/w %, or in an amount of 0.08-0.15 w/w %, or in an amount of 0.08-0.13 w/w %, or in an amount of 0.1-0.15 w/w %, or in an amount of 0.1-0.13 w/w %. In a further aspect, the product comprises the unsaturated emulsifier in an amount of 0.1 w/w %. In a further aspect, the product comprises the unsaturated emulsifier in an amount of 0.01-0.1, such as in an amount of 0.01-0.02 w/w %.

In a further aspect, the fermented milk product as described herein comprises mono- and diglycerides of unsaturated fatty acid(s) in an amount of 0.01-0.19 w/w %, or in an amount of 0.05-0.19 w/w %, or in an amount of 0.05-0.18 w/w %, or in an amount of 0.05-0.16 w/w %, or in an amount of 0.08-0.15 w/w %, or in an amount of 0.08-0.13 w/w %, or in an amount of 0.1-0.15 w/w %, or in an amount of 0.1-0.13 w/w %. In a further aspect, the product comprises mono- and diglycerides of unsaturated fatty acid(s) in an amount of 0.1 w/w %. In a further aspect, the product comprises mono- and diglycerides of unsaturated fatty acid(s) in an amount of 0.01-0.1 such as in an amount of 0.01-0.02 w/w %.

The invention may also be described by below embodiments:

### Embodiment 1

A fermented milk product comprising an unsaturated emulsifier in an amount of 0.01-0.19 w/w %.

### Embodiment 2

A fermented milk product comprising an unsaturated emulsifier in an amount of 0.05-0.19 w/w %.

### Embodiment 3

The fermented milk product according to any one of embodiments 1-2, wherein the fermented milk product comprises at least 0.3 w/w % fat.

### Embodiment 4

The fermented milk product according to any one of embodiments 1-3, wherein the fermented milk product comprises at least 0.5 w/w % fat.

### Embodiment 5

The fermented milk product according to any one of embodiments 1-4, wherein the product comprises between 0.3 and 15 w/w % fat, such as between 0.3 and 10 w/w % fat or between 0.3 and 8 w/w % fat or between 0.3 and 6 w/w % fat or between 0.4 and 6 w/w % fat, or between 0.4 and 4 w/w % fat or between 0.4 and 2 w/w % fat or between 0.4 and 1.8 w/w % fat.

### Embodiment 6

The fermented milk product according to any one of embodiments 1-5, wherein the product comprises the unsaturated emulsifier in an amount of 0.05-0.18 w/w %, or in an amount of 0.05-0.16 w/w %, or in an amount of 0.08-0.15 w/w %, or in an amount of 0.1-0.15 w/w %.

### Embodiment 7

The fermented milk product according to any one of embodiments 1-6, wherein the product comprises the unsaturated emulsifier in an amount of 0.01-0.1 w/w %.

### Embodiment 8

The fermented milk product according to embodiment 7, wherein the product comprises the unsaturated emulsifier in an amount of 0.01-0.02 w/w %.

### Embodiment 9

The fermented milk product according any one of embodiments 1-6, wherein the product comprises the unsaturated emulsifier in an amount of 0.1 w/w %.

### Embodiment 10

The fermented milk product according to any one of embodiments 1-9, wherein the unsaturated emulsifier comprises about 32% of unsaturated monoglyceride based on either hardened or partially hardened oil such as palm oil and/or rapeseed oil.

### Embodiment 11

The fermented milk product according to any one of embodiments 1-10, wherein the unsaturated emulsifier comprises mono- and diglycerides of unsaturated fatty acid(s).

### Embodiment 12

The fermented milk product according to embodiment 11, wherein the unsaturated emulsifier comprises at least 30 w/w % of mono- and diglycerides of unsaturated fatty acid(s), or such as at least 40 w/w % of mono- and diglycerides of unsaturated fatty acid(s) or such as at least 50 w/w % of mono- and diglycerides of unsaturated fatty acid(s).

### Embodiment 13

The fermented milk product according to any one of embodiments 11-12, wherein at least 50 w/w % of the mono- and diglycerides of unsaturated fatty acid(s) are in the cis form, such as at least 55 w/w % of the mono- and diglycerides of unsaturated fatty acid(s) are in the cis form or such as at least 57 w/w % of the mono- and diglycerides of unsaturated fatty acid(s) are in the cis form.

### Embodiment 14

The fermented milk product according to any one of embodiments 11-13, wherein said unsaturated fatty acid(s) are derived from oils and/or fats of vegetable and/or animal origin.

### Embodiment 15

The fermented milk product according to any one of embodiments 11-14, wherein said fatty acid(s) is selected from the group consisting of myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, and a mixture of said fatty acid(s).

### Embodiment 16

The fermented milk product according to any one of embodiments 1-15, wherein the product is a yogurt.

### Embodiment 17

The fermented milk product according to any one of embodiments 1-16, wherein the product is a drinking yogurt.

### Embodiment 18

The fermented milk product according to any one of embodiments 1-16, wherein the product is a stirred yogurt.

### Embodiment 19

The fermented milk product according to any one of embodiments 1-18, wherein the product has a pH between 3-5.

### Embodiment 20

The fermented milk product according to embodiment 19, wherein the product has a pH between 3.5-4.6.

### Embodiment 21

A method for preparing a fermented milk product having a decreased acidity by adding an unsaturated emulsifier in an amount of 0.05-0.19 w/w % to a milk product such as a yogurt milk.

### Embodiment 22

A method for preparing a fermented milk product having an increased fat sensation by adding an unsaturated emulsifier in an amount of 0.05-0.19 w/w % to a milk product such as a yogurt milk.

### Embodiment 23

A method for preparing a fermented milk product having an increased fat sensation and a decreased acidity by adding an unsaturated emulsifier in an amount of 0.05-0.19 w/w % to a milk product such as a yogurt milk.

### Embodiment 24

The method according to any one of embodiments 21-23, wherein the fermented milk product is as further defined in any one of embodiments 1-20.

### Embodiment 25

The method according to any one of embodiments 21-24, wherein the emulsifier is added to the milk product before homogenization, pasteurization and/or fermentation such as before homogenization, pasteurization and fermentation.

### Embodiment 26

Use of an unsaturated emulsifier in an amount of 0.01-0.19 w/w % for decreasing acidity perception in a fermented milk product.

### Embodiment 27

Use of an unsaturated emulsifier in an amount of 0.01-0.19 w/w % for increasing fat sensation in a fermented milk product.

### Embodiment 28

Use of an unsaturated emulsifier in an amount of 0.01-0.19 w/w % for increasing fat sensation and decreasing acidity perception in a fermented milk product.

### Embodiment 29

The use according to any one of embodiments 26-28, wherein the fermented milk product is as further defined in any one of embodiments 1-20.

### Embodiment 30

The use according to any one of embodiments 26-29, wherein the unsaturated emulsifier is as further defined in any one of embodiments 1-20.

### Embodiment 31

The use according to any one of embodiments 26-30, wherein the unsaturated emulsifier is added to the milk product before homogenization, pasteurization and/or fermentation such as before homogenization, pasteurization and fermentation.

### Embodiment 32

A fermented milk product comprising mono- and diglyceride(s) of unsaturated fatty acid(s) in an amount of 0.01-0.19 w/w %.

### Embodiment 33

The fermented milk product according to embodiment 32, wherein the fermented milk product further comprises at least 0.3 w/w % fat.

### Embodiment 34

The fermented milk product according to embodiment 32, wherein the fermented milk product further comprises at least 0.5 w/w % fat.

### Embodiment 35

The fermented milk product according to any one of embodiments 32-34, wherein the product comprises the mono- and diglycerides of unsaturated fatty acid(s) in an amount of 0.05-0.19 w/w %.

### Embodiment 36

The fermented milk product according to any one of embodiments 32-35, wherein the product comprises the mono- and diglycerides of unsaturated fatty acid(s) in an amount of 0.01-0.1 w/w %.

### Embodiment 37

The fermented milk product according to embodiment 36, wherein the product comprises the mono- and diglycerides of unsaturated fatty acid(s) in an amount of 0.01-0.02 w/w %.

### Embodiment 38

The fermented milk product according to any one of embodiments 32-37, wherein the product comprises between 0.3 and 15 w/w % fat, such as between 0.3 and 10 w/w % fat or between 0.3 and 8 w/w % fat or between 0.3 and 6 w/w % fat or between 0.4 and 6 w/w % fat, or between 0.4 and 4 w/w % fat or between 0.4 and 2 w/w % fat or between 0.4 and 1.8 w/w % fat.

### Embodiment 39

The fermented milk product according to any one of embodiments 32-38, wherein at least 50 w/w % of the mono- and diglycerides of unsaturated fatty acid(s) are in the cis form, such as at least 55 w/w % of the mono- and diglycerides of unsaturated fatty acid(s) are in the cis form or such as at least 57 w/w % of the mono- and diglycerides of unsaturated fatty acid(s) are in the cis form.

### Embodiment 40

The fermented milk product according to any one of embodiments 32-39, wherein said mono- and diglycerides of unsaturated fatty acid(s) are derived from oils and/or fats of vegetable and/or animal origin.

### Embodiment 41

The fermented milk product according to any one of embodiments 32-40, wherein said fatty acid(s) is selected from the group consisting of myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, and a mixture of said fatty acid(s).

### Embodiment 42

The fermented milk product according to any one of embodiments 32-41, wherein the product is a yogurt.

### Embodiment 43

The fermented milk product according to any one of embodiments 32-41, wherein the product is a drinking yogurt.

### Embodiment 44

The fermented milk product according to any one of embodiments 32-41, wherein the product is a stirred yogurt.

### Embodiment 45

The fermented milk product according to any one of embodiments 32-44, wherein the product has a pH between 3-5.

### Embodiment 46

The fermented milk product according to embodiment 45, wherein the product has a pH between 3.5-4.6.

### Embodiment 47

A method for preparing a fermented milk product having a decreased acidity perception by adding mono- and diglycerides of unsaturated fatty acid(s) in an amount of 0.01-0.19 w/w % to a milk product such as a yogurt milk.

### Embodiment 48

A method for preparing a fermented milk product having an increased fat sensation by adding mono- and diglycerides of unsaturated fatty acid(s) in an amount of 0.01-0.19 w/w % to a milk product such as a yogurt milk.

### Embodiment 49

A method for preparing a fermented milk product having an increased fat sensation and a decreased acidity perception by adding mono- and diglycerides of unsaturated fatty acid(s) in an amount of 0.01-0.19 w/w % to a milk product such as a yogurt milk.

### Embodiment 50

The method according to any one of embodiments 47-49, wherein the fermented milk product is as further defined in any one of embodiments 32-46.

### Embodiment 51

The method according to any one of embodiments 49-50, wherein the mono- and diglycerides of unsaturated fatty acid(s) is added to the milk product before homogenization, pasteurization and/or fermentation such as before homogenization, pasteurization and fermentation.

### Embodiment 52

Use of mono- and diglycerides of unsaturated fatty acid(s) in an amount of 0.01-0.19 w/w % for decreasing acidity perception in a fermented milk product.

### Embodiment 53

Use of mono- and diglycerides of unsaturated fatty acid(s) in an amount of 0.01-0.19 w/w % for increasing fat sensation in a fermented milk product.

### Embodiment 54

Use of mono- and diglycerides of unsaturated fatty acid(s) in an amount of 0.01-0.19 w/w % for increasing fat sensation and decreasing acidity perception in a fermented milk product.

### Embodiment 55

The use according to any one of embodiments 52-54, wherein the fermented milk product is as further defined in any one of embodiments 32-46.

### Embodiment 56

The use according to any one of embodiments 52-55, wherein the mono- and diglycerides of unsaturated fatty acid(s) is as further defined in any one of embodiments 32-46.

### Embodiment 57

The use according to any one of embodiments 52-56, wherein the mono- and diglycerides of unsaturated fatty acid(s) is added to the milk product before homogenization, pasteurization and/or fermentation such as before homogenization, pasteurization and fermentation.

The following examples illustrating the present invention represent specific embodiments of the invention and are not intended as limiting the scope of the invention.

### EXAMPLES

### Methods

The fat sensation, cream flavour, decrease in acidity (perception), decrease in powdery sensory were measured through a double blind sensory evaluation by a panel of 6 or 7 trained panellists to describe the texture of flavour of stirred yogurt through descriptive analysis method.

| UK | Definition |
|---|---|
| Acidic | Intensity of acidity |
| Fat sensation | Intensity of fat sensation |
| Cream flavour | Intensity of cream flavour |
| Powdery/dry | Intensity of drying powder taste |

The viscosity is measured using a Brookfield viscometer.

### Example 1

Yogurt stirred were prepared with the following constituents:

TABLE 1

| | Yogurt with | Yogurt with |
|---|---|---|
| | 0.5% fat | 1.5% fat |
| Skimmed milk | 97.996 | 95.766 |
| Cream, 38% fat | 0.604 | 3.334 |
| Sodium caseinate | 0.300 | 0.300 |
| Whey protein concentrate, 80% protein | 1.000 | 0.500 |
| GRINDSTED PS 217/B | 0.10 | 0.10 |
| YO-MIX 860 FRO* | + | + |
| Total | 100.00 | 100.00 |

*YO-MIX 860 FRO is starter culture (dosage 20 DCU/100 I of milk)

The procedure followed was as described below:

1—Mix all powder ingredients and add the dry blend to the milk under good agitation

### 2—Homogenise at 65° C./200 bar

3—Pasteurise 95° C. for 6 minutes
4—Cool to the fermentation temperature of 43° C.
5—Inoculate with the starter culture YO-MIXTM 860 FRO in a dosage of 20 DCU/100 I

### 6—Ferment to pH 4.60

7—Stir and cool on plate heat exchanger to 24° C.
8—Fill and store at 5° C.

### Example 2

The following stirred yogurts were prepared by the procedure described in example 1 and tested for intensity of acidity (acidic), intensity of fat sensation (fat sensation), intensity of cream flavour (cream flavour) and intensity of drying powder taste (powdery/dry).

TABLE 2

| | 1 | 2 | 3 | 4 | 5 | 6 |
|---|---|---|---|---|---|---|
| Ingredient name | | | | | | |
| Skimmed milk | 98.426 | 98.589 | 97.832 | 97.996 | 95.603 | 95.766 |
| Cream, 38% fat | 0.274 | 0.011 | 0.868 | 0.604 | 3.597 | 3.334 |
| Sodium caseinate | 0.300 | 0.300 | 0.300 | 0.300 | 0.300 | 0.300 |
| Whey protein concentrate, 80% | 1.000 | 1.000 | 1.000 | 1.000 | 0.500 | 0.500 |
| protein | | | | | | |
| GRINDSTED PS 217/B | | 0.10 | | 0.10 | | 0.10 |
| YO-MIX 860 FRO* | + | + | + | + | + | + |
| Total | 100.00 | 100.00 | 100.00 | 100.00 | 100.00 | 100.00 |
| Calculations | | | | | | |
| Total Fat | 0.28 | 0.28 | 0.50 | 0.50 | 1.50 | 1.50 |
| Total MSNF | 10.04 | 10.04 | 10.02 | 10.02 | 9.53 | 9.53 |
| Total dry matter | 10.31 | 10.31 | 10.52 | 10.51 | 11.03 | 11.02 |
| Total carbohydrate | 4.67 | 4.67 | 4.66 | 4.66 | 4.62 | 4.62 |
| Total protein | 4.52 | 4.52 | 4.51 | 4.51 | 4.10 | 4.10 |
| Analytical measurements | | | | | | |
| Viscosity, cP** | 4700 | 4700 | 4800 | 5300 | 3600 | 3700 |
| Polyvisc, mm/15 sec | 64 | 59 | 59 | 60 | 69 | 66 |
| pH | 4.27 | 4.28 | 4.27 | 4.29 | 4.28 | 4.28 |
| Syneresis, 30 min | 30.7 | 28.1 | 30.4 | 25.9 | 30.9 | 28.9 |
| Titer, ml NaOH/100 ml yogurt | 26.0 | 26.5 | 26.2 | 26.8 | 27.8 | 26.2 |
| Sensory evaluation*** | | | | | | |
| Acidity | 8.52 A | 8.97 A | 8.94 A | 8.18 A | 7.08A | 4.07B |
| Fat sensation | 6.15 D | 6.13 D | 5.96 D | 7.29CD | 8.21BC | 10.14AB |
| Cream Flavour | 4.7 C | 3.65 C | 4.5 C | 3.98 C | 8.61 B | 10.56 AB |
| Powdery/dry | 8.07 A | 8.91 A | 7.67 A | 8.41 A | 4.51 B | 3.63 B |

*dosage 20 DCU/100 I of milk.
**Brookfield, spindle S25, speed 30 RPM, time 30 sec, temperature 5° C.
***The fat sensation, cream flavour, decrease in acidity, decrease in powdery sensory were measured through a double blind sensory evaluation by a panel of 6 trained panellists to describe the texture of flavour of stirred yogurt through descriptive analysis method.
A, B, C, D refer to statistical grouping.

From the above table 2 it appears that the addition of 0.1% of the unsaturated emulsifier GRINDSTED PS217/B provides the following functionality in stirred yogurt:
No decrease in measured viscosity or sensory viscosity
Increase in fat sensation for yogurts with 0.5% and 1.5% fat containing unsaturated emulsifier when compared with yogurts with same fat content and without addition of the emulsifier.
Increase in cream flavour for yogurt with 1.5% fat
Decrease in acidity for yogurts with 0.5% and 1.5% fat containing unsaturated emulsifier when compared with yogurts with same fat content and without addition of the emulsifier.
Decrease in powdery for yogurt with 1.5% fat containing unsaturated emulsifier. No effect seen of unsaturated emulsifier in this trial for yogurt with 0.3% fat.

### Example 3

The following stirred yogurts were prepared by the procedure described in example 1 and tested for intensity of acidity (acidic), intensity of fat sensation (fat sensation), intensity of cream flavour (cream flavour) and intensity of drying powder taste (powdery/dry). The emulsifier used is DIMODAN® M090 comprising distilled monoglyceride:

TABLE 3a
Ingredients in %

| | Yogurt with | Yogurt with | Yogurt with |
|---|---|---|---|
| | 3% fat | 1.5% fat | 1.5% fat |
| | without | without | with |
| | DIMODAN ® | DIMODAN ® | DIMODAN ® |
| Ingredient Name | MO90 | MO90 | MO90 |
| Skimmed milk | 91.896 | 95.909 | 95.893 |
| Whey powder | 0.777 | 0.707 | 0.708 |
| concentrate | | | |
| (80% prot) | | | |
| Butter oil (AMF) | 0.100 | 0.100 | 0.100 |
| Cream 38% fat | 7.226 | 3.283 | 3.283 |
| YO-MIX ™ 860 | + | + | + |
| FRO* | | | |
| DIMODAN ® MO 90 | | | 0.016 |
| Total % | 100 | 100 | 100 |

TABLE 3b

| Calculations | 1 | 2 | 5 |
|---|---|---|---|
| Total Fat | 3.00 | 1.50 | 1.50 |
| Total MSNF | 9.21 | 9.31 | 9.31 |
| Total Dry Matter | 12.39 | 11.00 | 11.02 |
| Total Carbohydrate | 4.68 | 4.76 | 4.76 |
| Total Protein | 4.00 | 4.00 | 4.00 |

* dosage 20 DCU / 100 I of milk

TABLE 3c
Sensory evaluation**

| | | Yogurt with | Yogurt with | Yogurt with |
|---|---|---|---|---|
| | | 3% fat | 1.5% fat | 1.5% fat |
| Sensory | | without | without | with |
| param- | Sensory | DIMODAN ® | DIMODAN ® | DIMODAN ® |
| eter | desciption | MO90 | M090 | MO90 |
| Acidity | Level of | 8.3 - C | 10.1 - A | 8.18 - C |
| | acidic taste | | | |
| | in mouth | | | |
| Cream | Level of | 5.51 - A | 3.15 - C | 5.1 - A |
| | flavour from | | | |
| | dairy cream | | | |
| | in mouth | | | |
| Fat | Level of | 10.57 - A | 7.11 - C | 8.49 - B |
| percep- | fat texture | | | |
| tion | in mouth | | | |
| Astri- | Level of | 6.47 - C | 8.47 - A | 6.77 - C |
| gent/ | dryness after | | | |
| dry | swallowing | | | |
| | in mouth | | | |

**The sensory parameters acidity, cream, fat perception and astringent/dry were measured through sensory evaluation by a panel 7 trained panellists to describe the texture and flavour of stirred yogurt through analysis method. The sensory evaluation was repeated 6 times.
A, B & C refer to statistical grouping.

Acidity is significant at 0.1%

Cream is significant at 1%

Fat perception is significant at 0.1%

Astrigent/dry is significant at 0.1%

From the above table 3 a-c it appears that reducing the fat content from 3% to 1.5% will give yogurt, which is more acidic (less mild in flavour), has less cream flavour and less fat texture, and dryness level is increased, all of this due to less amount of fat.

Addition of DIMODAN MO 90 into yogurt with 1.5% will decrease the acidic level to a similar level as seen with a yogurt with 3% fat, increase the cream flavour to a similar level as with 3% fat, increase the fat texture towards that of higher fat content, but not on similar level as with 3% fat and reduce the dryness to a similar level as with 3% fat. So all in all addition of DIMODAN MO 90 into yogurt with less fat will adjust the sensory parameters to that of yogurt with higher fat content.

The foregoing applications, and all documents cited therein or during their prosecution (“appin cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

Various modifications and variations of the described embodiments will be apparent to those skilled in the art without departing from the scope and spirit of those embodiments. It should be understood that the subject matters as claimed should not be unduly limited to such specific embodiments. Indeed, various modifications of the described modes for carrying out the embodiments that are obvious to those skilled in the art are intended to be within the scope of the following claims.

1. A fermented milk product comprising an unsaturated emulsifier in an amount of 0.01-0.19 w/w %, wherein the fermented milk product comprises at least 0.3 w/w % fat.

2. The fermented milk product according to claim 1, wherein the product comprises the unsaturated emulsifier in an amount of 0.05-0.19 w/w %.

3. The fermented milk product according to claim 1, wherein the product comprises the unsaturated emulsifier in an amount of 0.01-0.1 w/w %.

4. The fermented milk product according to claim 1, wherein the product comprises the unsaturated emulsifier in an amount of 0.01-0.02 w/w %.

5. The fermented milk product according to claim 1, wherein the fermented milk product comprises at least 0.5 w/w % fat.

6. The fermented milk product according to claim 1, wherein the product comprises between 0.3 and 15 w/w % fat, such as between 0.3 and 10 w/w % fat or between 0.3 and 8 w/w % fat or between 0.3 and 6 w/w % fat or between 0.4 and 6 w/w % fat, or between 0.4 and 4 w/w % fat or between 0.4 and 2 w/w % fat or between 0.4 and 1.8 w/w % fat.

7. The fermented milk product according to claim 1, wherein the unsaturated emulsifier comprises mono- and diglycerides of unsaturated fatty acid(s).

8. The fermented milk product according to claim 7, wherein the unsaturated emulsifier comprises at least 30 w/w % of mono- and diglycerides of unsaturated fatty acid(s), or such as at least 40 w/w % of mono- and diglycerides of unsaturated fatty acid(s) or such as at least 50 w/w % of mono- and diglycerides of unsaturated fatty acid(s).

9. The fermented milk product according to claim 7, wherein at least 50 w/w % of the mono- and diglycerides of unsaturated fatty acid(s) are in the cis form or such as at least 55 w/w % of the mono- and diglycerides of unsaturated fatty acid(s) are in the cis form or such as at least 57 w/w % of the mono- and diglycerides of unsaturated fatty acid(s) are in the cis form.

10. The fermented milk product according to claim 7, wherein said unsaturated fatty acid(s) are derived from oils and/or fats of vegetable and/or animal origin.

11. The fermented milk product according to claim 1, wherein the product is a yogurt such as a drinking yogurt or a stirred yogurt.

12. A method for preparing a fermented milk product having an increased fat sensation and/or a decreased acidity perception by adding an unsaturated emulsifier in an amount of 0.01-0.19 w/w % to a milk product such as a yogurt milk.

13. The method according to claim 12, wherein the fermented milk product comprises the fermented milk product of claim 1.

14. The method according to claim 12, wherein the emulsifier is added to the milk product before homogenization, pasteurization and/or fermentation such as before homogenization, pasteurization and fermentation.

15.-18. (canceled)

19. A fermented milk product comprising mono- and diglyceride(s) of unsaturated fatty acid(s) in an amount of 0.01-0.19 w/w %.

20. The fermented milk product according to claim 19, wherein the fermented milk product further comprises at least 0.3 w/w % fat.

21. The fermented milk product according to claim 19, wherein the fermented milk product further comprises at least 0.5 w/w % fat.

22. The fermented milk product according to claim 19, wherein the product comprises the mono- and diglycerides of unsaturated fatty acid(s) in an amount of 0.05-0.19 w/w %.

23. The fermented milk product according to claim 19, wherein the product comprises the mono- and diglycerides of unsaturated fatty acid(s) in an amount of 0.01-0.1 w/w %.

24. The fermented milk product according to claim 19, wherein the product comprises the mono- and diglycerides of unsaturated fatty acid(s) in an amount of 0.01-0.02 w/w %.

25. The fermented milk product according to claim 19, wherein the product comprises between 0.3 and 15 w/w % fat, such as between 0.3 and 10 w/w % fat or between 0.3 and 8 w/w % fat or between 0.3 and 6 w/w % fat or between 0.4 and 6 w/w % fat, or between 0.4 and 4 w/w % fat or between 0.4 and 2 w/w % fat or between 0.4 and 1.8 w/w % fat.

26. The fermented milk product according to claim 19, wherein at least 50 w/w % of the mono- and diglycerides of unsaturated fatty acid(s) are in the cis form, such as at least 55 w/w % of the mono- and diglycerides of unsaturated fatty acid(s) are in the cis form or such as at least 57 w/w % of the mono- and diglycerides of unsaturated fatty acid(s) are in the cis form.

27. The fermented milk product according to claim 19, wherein said mono- and diglycerides of unsaturated fatty acid(s) are derived from oils and/or fats of vegetable and/or animal origin.

28. The fermented milk product according to claim 19, wherein the product is a yogurt such as a drinking yogurt or a stirred yogurt.

29. A method for preparing a fermented milk product having an increased fat sensation and/or a decreased acidity perception by adding mono- and diglycerides of unsaturated fatty acid(s) in an amount of 0.01-0.19 w/w % to a milk product such as a yogurt milk.

30. The method according to claim 29, wherein the fermented milk product comprises the fermented milk product of claim 1.

31. The method according to claim 29, wherein the mono- and diglycerides of unsaturated fatty acid(s) is added to the milk product before homogenization, pasteurization and/or fermentation such as before homogenization, pasteurization and fermentation.

32.-35. (canceled)
